(19) United States
(12) Patent Application Publication
(10) Pub. No.: US 2009/0178767 A1
(43) Pub. Date: Jul. 16, 2009

(54) Tape cutter with an arrangement for retracting a cutting blade after cutting tape

(76) Inventor: Syue-Jin Shen, Taipei (TW)

Correspondence Address: SAM CHEN, 7F-1, 293, ROOSEVELT ROAD, SEC 3, TAIPEI, TW

(21) Appl. No.: 12/013,465

(22) Filed: Jan. 13, 2008

(51) Int. Cl. B32B 37/00

(52) U.S. Cl. 156/510

(57) ABSTRACT

A tape cutter is disclosed that includes a spring actuated safety arrangement which, after cutting tape by pivoting a cutting blade by pushing a trigger member on the cutter body, is adapted to retract the cutting blade into the cutter body by releasing the trigger member. Additionally, a closing unit is pivotably disposed in a tape opening to contact the end of the tape, the closing unit having a projecting lid adapted to either open or close the tape opening.

### BACKGROUND OF THE INVENTION

1. Field of Invention

The invention relates to tape cutters and more particularly to such a tape cutter having a spring actuated safety arrangement for retracting a cutting blade into the tape cutter after cutting tape.

2. Description of Related Art

A conventional tape cutter is shown in FIG. 1 and comprises a cutter body C, an adhesive tape roll B rotatably mounted in the cutter body C, and a rear spring A biased between an inner wall of the cutter body C and the back of the adhesive tape roll B. However, the well known tape cutter suffers from a disadvantage. In detail, the spring A may bounce out of the cutter body C when a user mounts a new tape roll B for replacement.

There have been numerous suggestions in prior patents for tape cutter. For example, U.S. Pat. No. 4,097,328 discloses a tape cutter with a swing member which is adapted to cut tape after releasing. Thus, continuing improvements in the exploitation of tape cutter are constantly being sought.

### SUMMARY OF THE INVENTION

It is therefore one object of the invention to provide a tape cutter having a spring actuated safety arrangement which, after cutting tape by a cutting blade by pushing a trigger member on the cutter body, is adapted to retract the cutting blade into the cutter body by releasing the trigger member.

The above and other objects, features and advantages of the invention will become apparent from the following detailed description taken with the accompanying drawings.

### BRIEF DESCRIPTION OF THE DRAWINGS

FIG. 1 is a longitudinal sectional view of a conventional tape cutter;

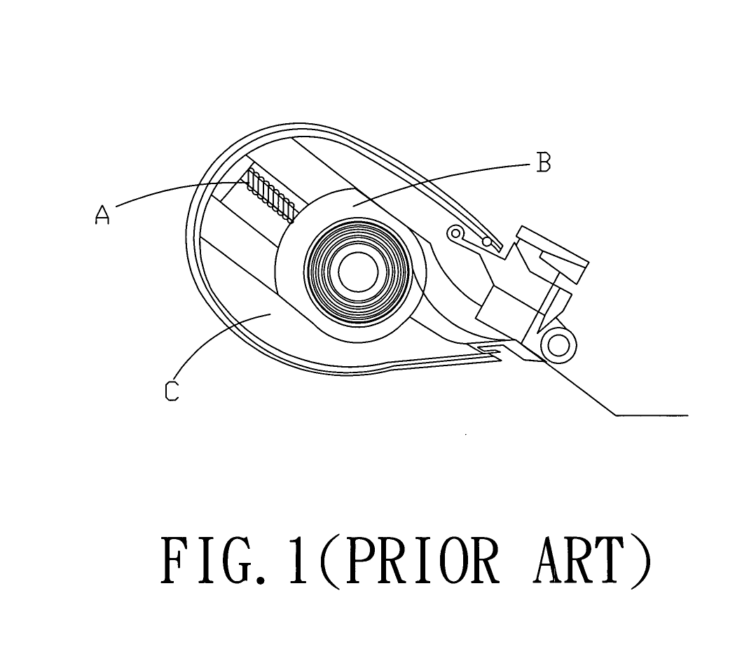

FIG. 2 is a perspective view of a preferred embodiment of tape cutter according to the invention;

FIG. 3 is an exploded view of the tape cutter according to the invention;

FIG. 4 is another exploded view of the tape cutter according to the invention;

FIG. 5 is a longitudinal sectional view of the tape cutter of FIG. 2;

FIG. 6 is a view similar to FIG. 5 where the tape leaving the tape cutter presses against the surface of an open paper container;

FIG. 7 is a view similar to FIG. 6 where the tape has been cut to adhere to the surface of the container;

FIG. 8 is a view similar to FIG. 7 where after sealing the container, cutting tape, and releasing the trigger member, the energized spring indirectly pivots the cutting blade counterclockwise to retract into the cutter body;

FIG. 9 is a schematic longitudinal sectional view of the tape cutter of FIG. 2 showing the spring in an uncompressed state;

FIG. 10 is a view similar to FIG. 9 where the spring is being compressed corresponding to FIG. 7;

FIG. 11 is a view similar to FIG. 9 where the spring is expanding corresponding to FIG. 8;

FIG. 12 is another perspective view of the tape cutter according to the invention where the tape opening is open; and

FIG. 13 is a view similar to FIG. 12 where the tape opening is closed by the lid.

### DETAILED DESCRIPTION OF THE INVENTION

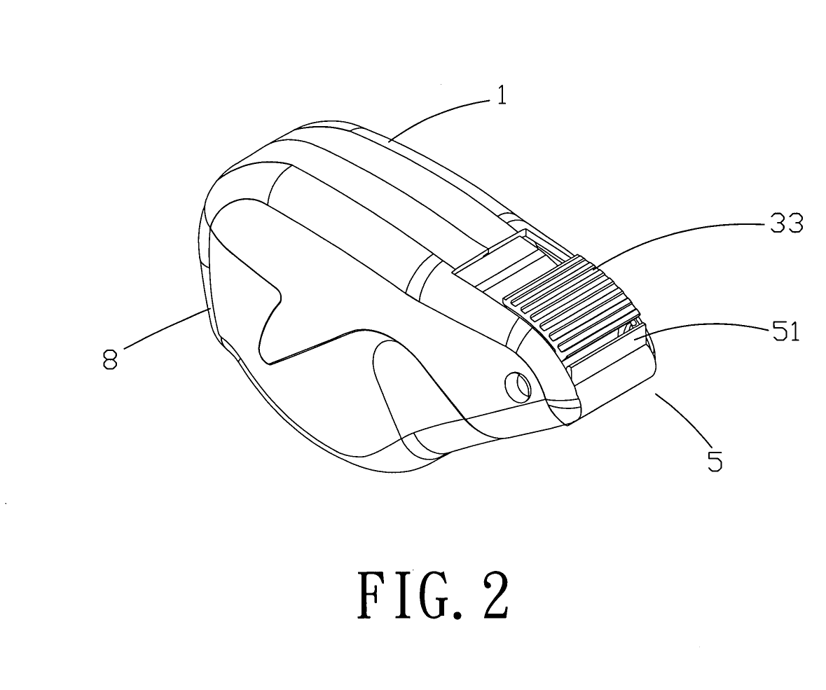

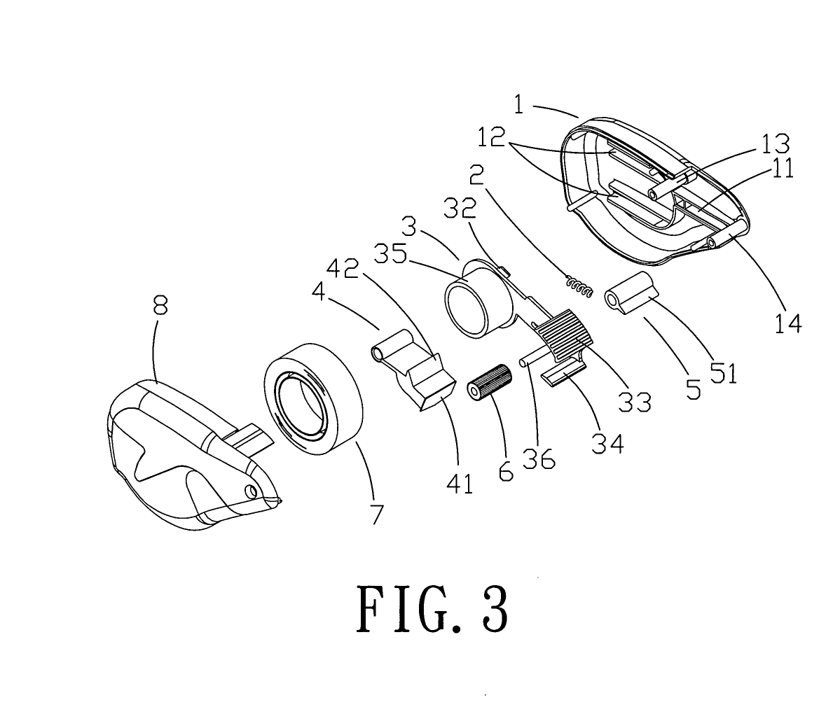

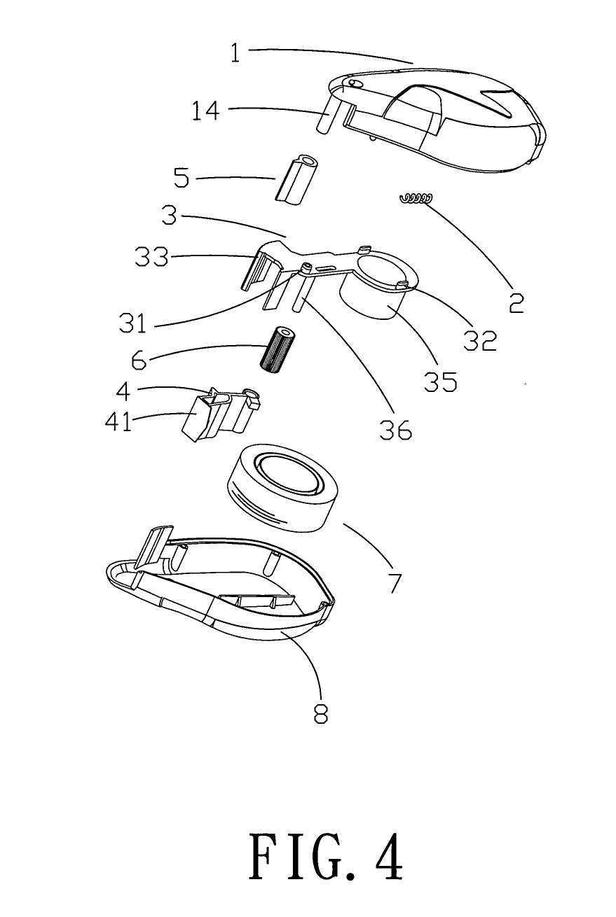

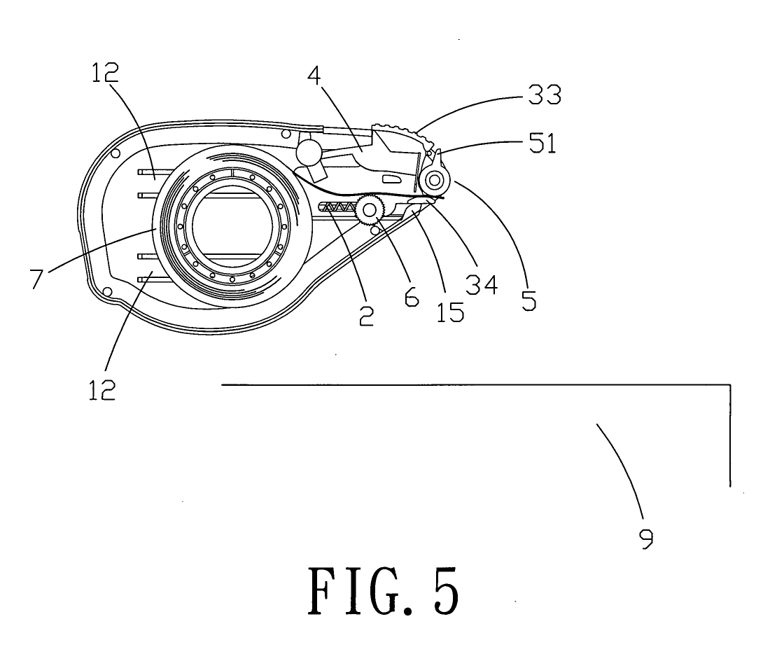

Referring to FIGS. 2 to 11, a tape cutter in accordance with a preferred embodiment of the invention is shown. The tape cutter comprises a first half shell 1, a spring (e.g., compression spring) 2, a pushing unit 3, a blade unit 4, a closing unit 5 having a projecting lid 51, a gear wheel 6, an adhesive tape roll 7, and a second half shell 8. Each component is discussed in detail below.

The first half shell 1 comprises an elongated cavity 11 having a forward opening, two parallel grooved rails 12 provided rearward of the cavity 11, an intermediate shaft 13, a forward shaft 14 with the closing unit 5 rotatably mounted thereon, and an anchoring member 15 spaced from the forward shaft 14 and disposed thereunder. The second half shell 8 has a structure adapted to matingly secure to the first half shell 1 to form a complete cutter body. The spring 2 is anchored in the cavity 11. The pushing unit 3 comprises on one side a forward prong 31 urged by the forward end of the spring 2, and two rear opposing sliding members 32 slidably provided in the rails 12. The pushing unit 3 further comprises on the other side a rear tubular tape mount 35 with the tape roll 7 rotatably mounted thereon, a knurled trigger member 33, a forward positioning member 34 provided upon the anchoring member 15 and spaced from the closing unit 5 to define an opening or a path therebetween to allow the tape 71 of the tape roll 7 to frictionally pass through, and a shaft 36 with the gear wheel 6 rotatably mounted thereon. The blade unit 4 comprises a rear sleeve (not numbered) rotatably mounted on the intermediate shaft 13, an intermediate ridge 42 urged against the rear edge on the bottom of the trigger member 33, and a forward cutting blade 41 disposed above the anchoring member 15 with the tape 71 passing therebetween.

Normally, the tape 71 of the tape roll 7 is pulled a predetermined distance to pass the surface of the gear wheel 6 and has its end pressed between the positioning member 34 and the shaft portion of the closing unit 5. That is, the gear wheel 6 serves as a guide roll for forwarding the tape 71.

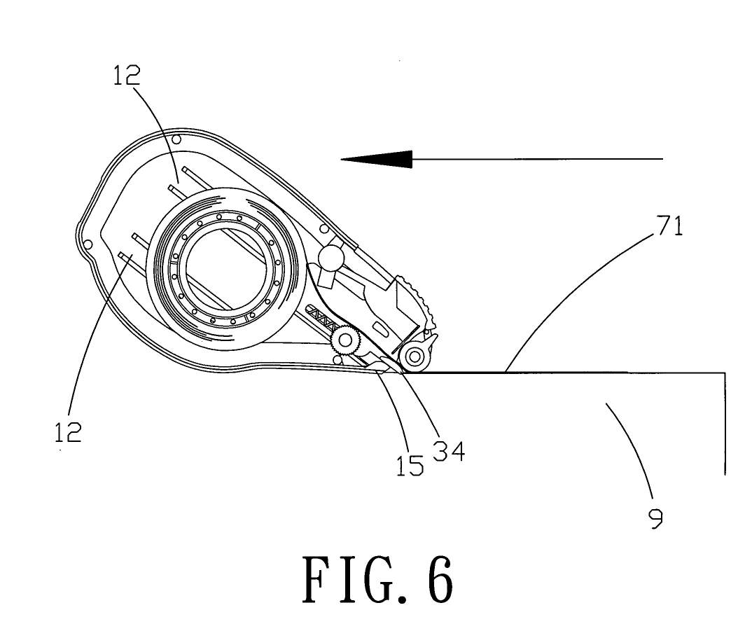

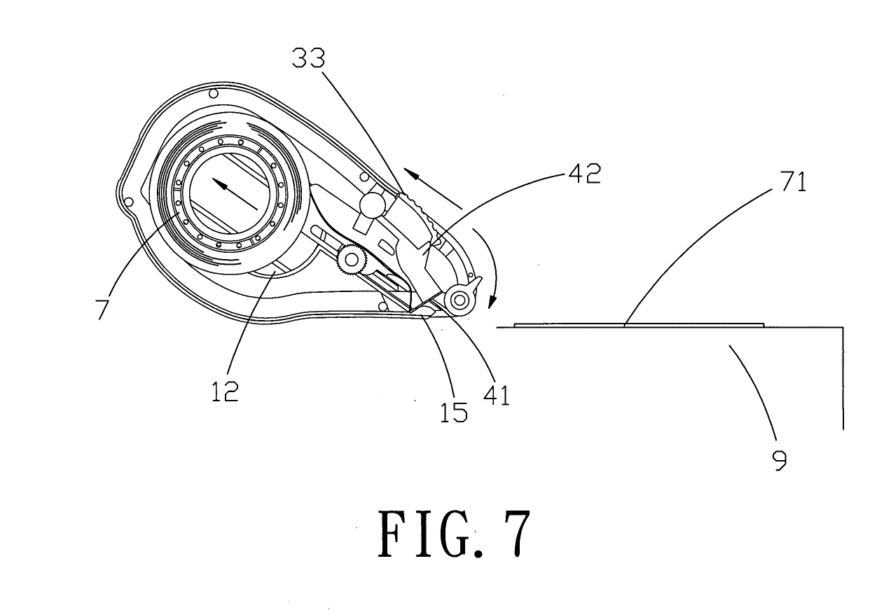

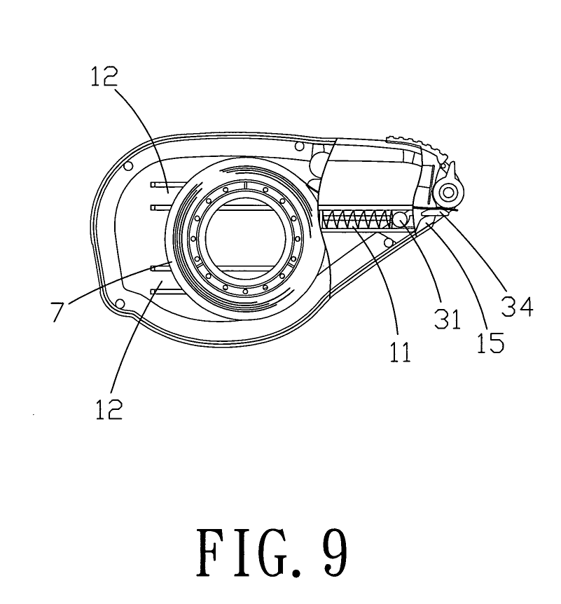

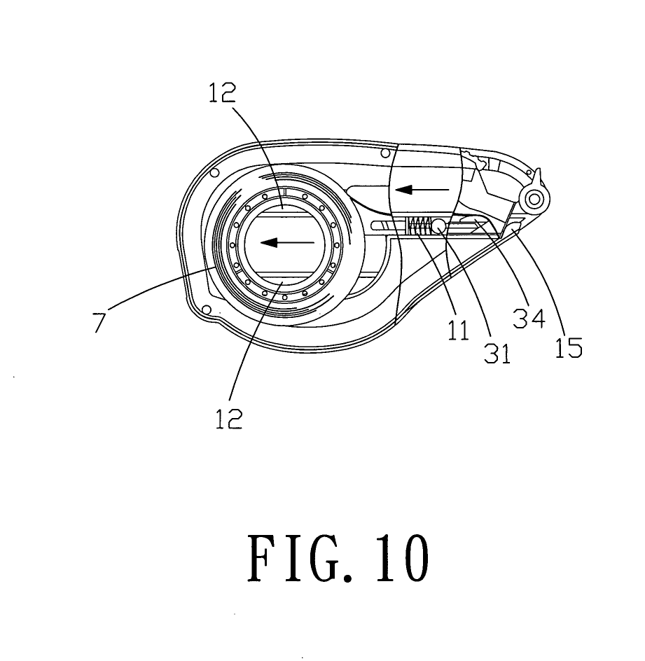

A tape cutting operation of tape cutter of the invention will be described in detail below. A user may place the tape cutter on a surface of a paper container 9 to be sealed. Next, pull the tape 71 out of the tape cutter for a desired length (see FIG. 6). Next, rearward push the trigger member 33 along the surface between the ridge 42 and the rear end of the blade unit 4 to slide the pushing unit 3 rearward along the rails 12 with the tape roll 7 also rearward moving (see FIG. 7). The ridge 42 is thus pressed by the trigger member 33 to pivot clockwise because the rear end (i.e., the sleeve) of the blade unit 4 serves as a pivot point. As a result, the cutting blade 41 cuts the tape 71. At the same time, the expanded spring 2 is compressed by the prong 31 to store elastic force in the process of pushing the trigger member 33 (see FIGS. 9 and 10).

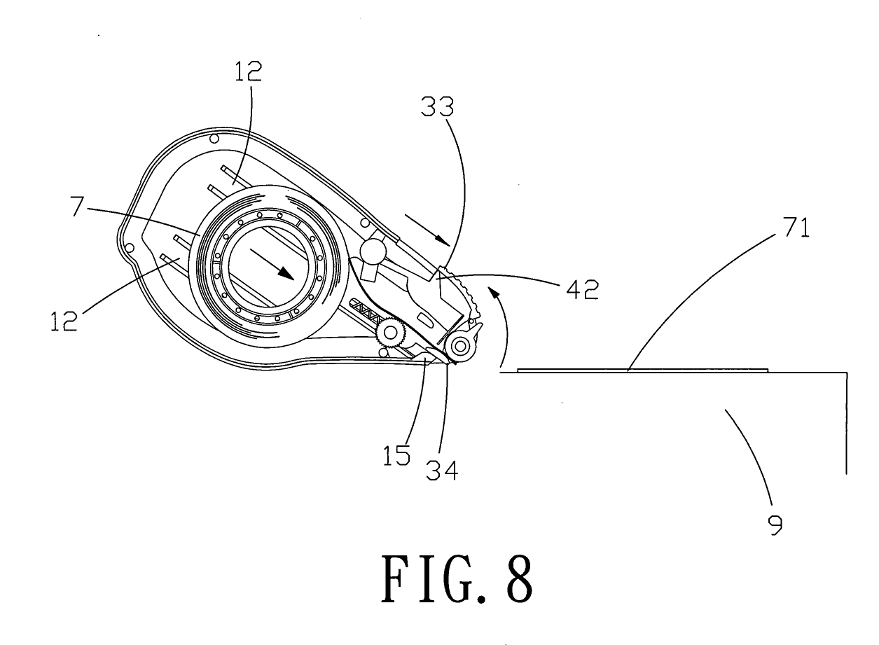

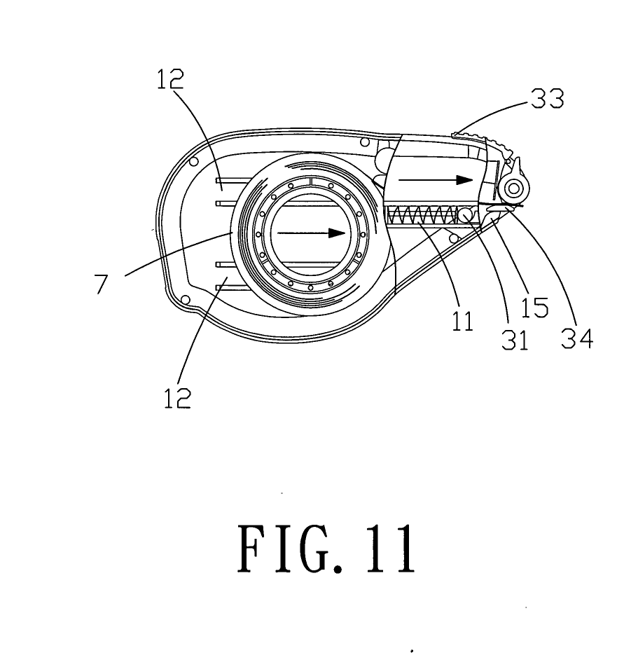

The energized spring 2 immediately pushes the prong 31 forward after releasing the trigger member 33 (see FIG. 11). As such, the trigger member 33 is pushed forward along the surface between the ridge 42 and the rear end of the blade unit 4 to slide the pushing unit 3 forward along the rails 12 with the tape roll 7 also forward moving (see FIG. 8). The ridge 42 is thus free to pivot counterclockwise. As a result, the cutting blade 41 retracts to its inoperative position inside the tape cutter. The user thus does not need to worry about being hurt by the cutting blade 41 carelessly since the cutting blade 41 has retracted into the tape cutter.

Preferably, the closing unit 5 is formed of an adhesive-resistant material so that the tape 71 may not stick with the closing unit 5. Otherwise, the tape cutting operation may be interfered undesirably.

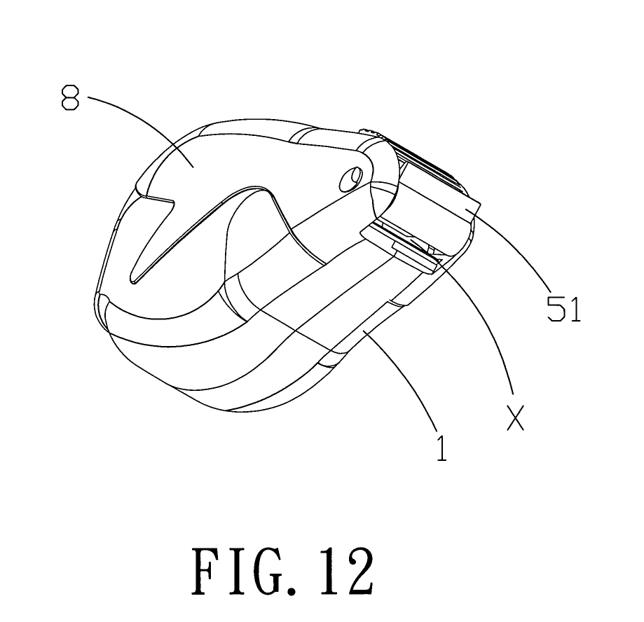

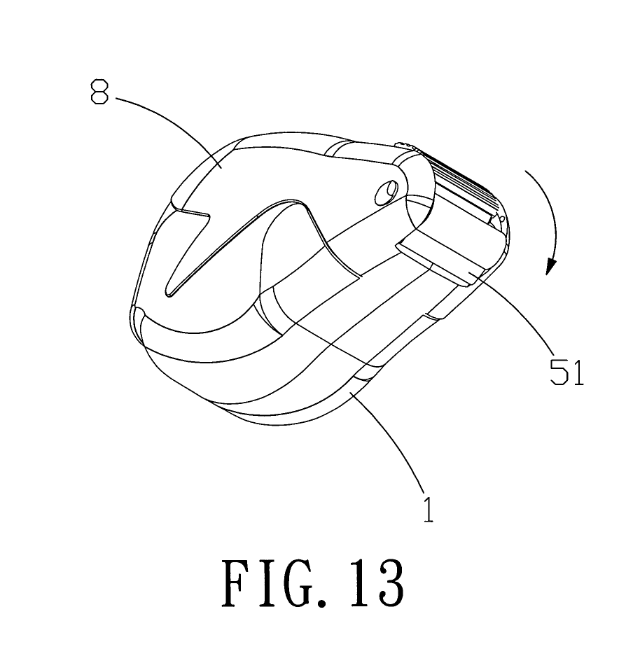

Referring to FIGS. 12 and 13, a user may clockwise pivot the lid 51 about the forward shaft 14 to close a tape opening X when the tape cutter is not in use for a prolonged period of time. This has the benefit of preserving the adhesive nature of the tape 71.

While the invention herein disclosed has been described by means of specific embodiments, numerous modifications and variations could be made thereto by those skilled in the art without departing from the scope and spirit of the invention set forth in the claims.

What is claimed is:

1. A tape cutter comprising:
a cutter body;
a spring biased pushing unit slidably disposed in the cutter body and including a trigger member on the cutter body, and a forward positioning member together with the trigger member to define an opening therebetween;
a guide wheel;
an adhesive tape roll rotatably mounted on the pushing unit and having a continuous tape with a portion being pulled to dispose on the guide wheel and the positioning member and terminate at the opening; and
a pivotal blade unit including an intermediate ridge urged against the bottom of the trigger member, and a forward cutting blade inside the cutter body, being proximate the opening, and being spaced from the tape,
whereby pulling the tape out of the opening for a length, and rearward pushing the trigger member along a surface defined between the ridge and the rear end of the blade unit will elastically slide the pushing unit rearward to press the ridge and pivot the cutting blade in a first direction to cut the tape; and
whereby releasing the trigger member will elastically push the trigger member forward to free the ridge and pivot the cutting blade in a second direction opposing the first direction to retract the cutting blade into the tape cutter.

2. The tape cutter of claim 1, wherein the cutter body comprises two parallel grooved rails, and wherein the pushing unit further comprises two rear opposing sliding members slidably mounted in the rails.

3. The tape cutter of claim 1, further comprising a closing unit pivotably disposed in the opening to contact the end of the tape, the closing unit having a projecting lid adapted to either open or close the opening.

4. The tape cutter of claim 3, wherein the closing unit is formed of an adhesive-resistant material.
